(19) United States
(12) Patent Application Publication
(10) Pub. No.: US 2023/0317973 A1
(43) Pub. Date: Oct. 5, 2023

(54) GREEN PAPER FOR PRODUCING A GAS DIFFUSION LAYER FOR A FUEL CELL

(71) Applicant: GIESECKE+DEVRIENT CURRENCY TECHNOLOGY GMBH, Munchen (DE)

(72) Inventors: Karlheinz MAYER, Grunenbach (DE); Alexander TANTSCHER, Dresden (DE)

(21) Appl. No.: 18/024,885

(22) PCT Filed: Aug. 31, 2021
(86) PCT No.: PCT/EP2021/025327

§ 371 Date: Mar. 6, 2023

(30) Foreign Application Priority Data
Sep. 7, 2020 (DE) 10 2020 005 480.3

(51) Int. Cl. H01M 8/0243; D21F 11/00; D21F 11/06; D21F 11/14

(52) U.S. Cl. CPC H01M 8/0243; D21F 11/006; D21F 11/06; D21F 11/14

(57) ABSTRACT

A green paper is provided for producing a gas diffusion layer (GDL) for a fuel cell. A process is for producing a green paper for producing a gas diffusion layer (GDL) for a fuel cell. The green paper includes at least one first, watermarked paper web. The watermark forms the patterning for the flow field or gas distribution structure of the gas diffusion layer (GDL) produced from the green paper. The first paper web is admixed with metal powder and/or metal fibres. The eventual GDL is formed after debindering, sintering, coating, deposition of atomic layers (ALD—atomic layer deposition) and further operating steps.

The invention relates to a green paper for producing a gas diffusion layer (GDL) for a fuel cell. The invention additionally relates to a process for producing a green paper for producing a gas diffusion layer (GDL) for a fuel cell.

In the case of a fuel cell of the proton exchange membrane fuel cell (PEMFC) type, also referred to as polymer electrolyte fuel cell, the distribution of gas is achieved via a bipolar plate (BPP) and the gas diffusion layer (GDL) to the membrane coated with catalytic platinum (and also referred to as CL or catalyst layer). The overall construction between two bipolar plates is also referred to as a membrane-electrode assembly (MEA).

Under the catalytic oxidation of hydrogen and oxygen, the fuel cell produces electrical power, water vapor, and heat.

For the automotive sector, a GDL is now established which is produced from a fiber material, such as from carbon fibers, for example, and a coated steel BPP. The fiber material here may be embodied as a woven/knitted textile fabric or as a fiber mat produced by paper technology, said mat being known from DE 10 2008 042 415 B3, for example. The material may also consist of two plies: a fine ply bordering the CL, and a coarser ply bordering the BPP and the flow field.

The fiber mat produced by paper technology is referred to as green paper or sinter paper, and in one of the following working steps is debindered and/or sintered and so further-processed into a GDL.

A particular disadvantage when producing GDLs based on carbon fibers is that carbon fibers and also their further processing are associated with relatively high costs. Furthermore, carbon fibers are sensitive to pressure, and this may lead to the breaking of fibers, which may then possibly damage the CL/PEM. Furthermore, the carbon fibers may bow or swell and, in so doing, penetrate the channels of the BPP, so diminishing the transitory flow of gas and water and impairing the efficiency of the fuel cell. Furthermore, there are limits to the adjustability of the GDL porosity, and for a two-layer GDL with a combination of coarse and fine porosity, at least two additional working steps are needed.

Lastly, the flow field has to be formed entirely by the BPP, because a GDL known from the prior art does not afford any possibility for patterning. For this purpose, the BPP must be embossed or the green paper must be processed in order to achieve a gas distribution structure or patterning for the flow field. This is in general a separate, costly and inconvenient procedure.

It is therefore an object underlying the invention to develop a generic green paper for producing a gas diffusion layer (GDL) for a fuel cell, and also a generic process for producing a green paper for producing a gas diffusion layer (GDL) for a fuel cell, in such a way that the disadvantages of the prior art are eliminated.

This object is achieved by the features of the independent claims. Developments of the invention are subjects of the dependent claims.

In the invention the green paper has at least one first paper web, in which at least one watermark is made. This watermark forms the patterning for the flow field or the gas distribution structure of the gas diffusion layer (GDL) produced from the green paper. With particular preference the first paper web is admixed with metal powder and/or metal fibers. The eventual GDL is formed after debindering, sintering, coating, deposition of atomic layers (ALD—atomic layer deposition) and, optionally, further operating steps.

The invention further relates to a process for producing a green paper for producing a gas diffusion layer (GDL), wherein at least one first paper web, preferably admixed with metal powder and/or metal fibers, is generated, in which at least one watermark is made. This paper web is subsequently processed by debindering, sintering, coating, deposition of atomic layers (ALD—atomic layer deposition) by means of the thermal ALD process, and, optionally, by further operating steps to form the eventual GDL.

After the sintering, all of the organic constituents of the green paper are pyrolyzed and therefore no longer present in the GDL: the GDL consists almost exclusively of a metal framework. The porosity of the metal framework, according to the current view, is dependent in particular on the fiber density of the paper webs, on the (grain) size of the metal powders and/or metal fibers and added additives.

It has surprisingly emerged that a green paper produced by papermaking can be patterned, by introduction of a watermark into a paper web of the green paper, in such a way that costly and inconvenient embossing of the BPP or post-processing of the green paper or of the GDL produced from the green paper is done away with or at least can be embodied more simply.

In the invention the subsequent flow field is integrated into the green paper without a separate operation of work, by integrating a corresponding watermark into the watermark ply on the cylindrical wire of a paper machine. In this case, without particular cost and complexity, through the design-dependent patterning of the watermark screen, with the associated thickness modulation of the paper, any desired shape and gradation of the flow field channels can be achieved. In order to increase the resolution of the patterning, it is also possible to employ a high-resolution or multistage watermark, as is known, for example, from EP 1432868 A1 or WO 2014/040706 A1.

A watermark in the sense of this invention is a true watermark, in which the thickness of the paper varies but the density of the paper does not vary. The paper in this case has regions which have a greater and/or lesser thickness than the adjacent regions, with the density of the paper being the same in all regions. A watermark of this kind may on the one hand be made in the paper web during papermaking, by introducing depressions or elevations into a cylindrical wire, for example, with a greater or lesser quantity of paper fibers accumulating at these depressions or elevations during the creation of the paper from the pulp. Alternatively, the watermark may be made in the paper web subsequently, by ablating parts of the paper—for example, mechanically by milling or by lasering.

Alternatively, a false watermark is also possible, wherein the paper web, still wet, is embossed by an embossing procedure after the paper web has been removed from, for example, the cylindrical wire. A watermark of this kind is also referred to as a dandy roll watermark. The embossing reduces the thickness of the paper, but at the same time the density of the paper is increased. The paper fibers are therefore densified or compressed. An advantage of this densification is that it prevents excessive gas diffusing through the GDL in the direction of the catalyst layer (CL) even in the leading region of the channel, and accordingly it ensures a more uniform gas distribution.

With particular preference a true watermark and a false watermark can be combined with one another by, for example, forming parts of a watermark by a true watermark and other parts by a false watermark.

According to a further preferred embodiment, the green paper consists of a first paper web and of at least one second paper web. The green paper in this case is formed from the first paper web and at least one second paper web. The second paper web in the still-wet state is brought together with and joined firmly to the first paper web. In this case the second and/or any further paper web may also have a watermark.

The first and/or at least one second paper web may be generated here in a cylindrical paper machine. Alternatively, the first and/or at least one second paper web may also be generated in a short former, in which the paper stock is applied via nozzle to a cylindrical wire. These production processes are known for the production of security documents or documents of value, such as banknotes or identity cards, from WO 2006/099971 A2, and are also processes preferred in the invention for producing a GDL from at least one paper web.

Accordingly, in one operation of work, the green paper highly filled with metal powder and/or metal fibers is formed, and according to DE 10 2008 042 415 B3 is processed with at least two different formulations to give a combined green paper having different properties. For the fuel cell these are, for example, a thin ply with fine pores and a thicker ply with coarser pores. The porosity as well may vary between two paper webs.

It is particularly advantageous, furthermore, if the green paper consists of two paper webs, each having a watermark, where the patterns of the watermark of the first paper web and of the watermark of the second paper web are not identical, but instead are precisely mirror-symmetrical in the area and in the material-thickness direction. Expressed alternatively, the patterns of the watermark of the first paper web are phase-shifted by 180° relative to the structures of the watermark of the second paper web. This means that when the first paper web and the second paper web are assembled by their sides patterned by the watermark, the elevations of the first paper web coincide with the depressions of the second paper web. A particular advantage of this embodiment is that, after sintering, the first and second paper webs may have a different porosity. For example, the first paper web, which is facing the membrane, has a lower porosity of 20% to 75% after sintering, and the second paper web has a higher porosity of 30% to 90% after sintering, with the consequence that the second paper web acts hardly as resistance to the gas, instead acting only as a spacer relative to the bipolar plate. In this way, an optimal gas distribution can be combined with optimal stackability and optimally uniform distribution of the mechanical pressure over the entire PEM membrane. With particular advantage there is a micro-porous layer (MPL) located between the first paper web and the membrane, this layer having a fine surface with less roughness and smaller pores than the first and second paper webs.

According to one preferred embodiment the first paper web has a higher density than the second paper web. The first paper web has for example a density of 3 g/cm³ to 10 g/cm³, the second a density of 1 g/cm³ to 5 g/cm³. With particular preference here the first paper web is formed by a finer paper fiber slurry than the second paper web, leading correspondingly to finer pores in this subregion of the sinter paper.

The thickness of the first paper web is preferably 5 μm to 50 μm, more preferably 10 μm to 20 μm, and that of the second paper web 50 μm to 400 μm, more preferably 80 μm to 200 μm.

According to a further preferred embodiment, the watermark is configured as a depression in the form of at least one channel, with the channel serving to transmit gas, namely the fuel or the oxygen. This channel is preferably embodied in a serpentine form over the area of the paper web. Alternative possibilities include multiple channels, in lattice form or ray form with connecting channels of circle-segment type.

In one or more of the paper plies, there may also be additional channels made for water transport according to one of the processes described above. These channels ensure a balanced transport of water and have the particular advantage that the PEM cell neither is flooded nor dries out, since both of these have adverse consequences for the efficiency of the cell. On the other hand, water channels can also be used for the sustained cooling of the cell.

According to a further preferred embodiment, a patterning by lasering is made in the surface of the green paper or of the sintered green paper, additionally to the watermark. The advantage of this is that a laser beam, for example, allows deeper patterns or patterns having steeper side walls to be made, or that existing patterns can be deepened or provided with steeper side walls. Furthermore, lasering may also take place in one or more former plies, in order to introduce patternings or channels into the interlayer between watermark and former plie and so to improve the gas distribution further still.

According to a further preferred embodiment, the gases are coupled into the GDL in the middle of the bipolar plates (based on a plan view of the bipolar plates) and are then distributed by way of various watermark patterns and/or channels of the GDL toward the outside or toward the outer edge of the GDL. These watermark patterns and/or channels may lead outward, for example, starting from the middle of the GDL, in ray form or spiral form, which may be supplemented by concentric annular watermark patterns and/or channels.

The GDL typically has an area of 300 cm² to 350 cm² and is between 100 μm to 300 μm thick according to system and function. If the function of the flow field is also integrated into the GDL, the thickness of the GDL may also be greater. The depth of the channels is up to 350 μm. Since the GDL must also have a certain compressibility and at the same time must conduct the power between the individual cells, the GDL with former ply and cylindrical wire ply has a thickness of 100 μm to 400 μm, and the BPP is to be embodied as a smooth plate having a thickness of 75 μm or less. Since typically the BPP also takes on a cooling function for the fuel cell, the BPP in that case may also be embodied as a composite sandwich which has a porous or channellike passage for coolant. Alternatively the cooling channels may also be integrated into the GDL or MEA.

According to a further preferred embodiment, the BPP has a simplified flow field pattern and additionally a partial flow field is generated in the GDL. The former ply in this case has a thin embodiment, so as to not take up too much space.

The cell pitch is preferably 0.8 mm to 1 mm, since for a 120 kW fuel cell in an automotive application, about 400 cells are stacked on one another. The fine former ply preferably has a thickness of between 5 μm and 50 μm. The former ply preferably has a fraction of 2% to 40% in the overall GDL.

According to a further preferred embodiment, high-resolution or multistage watermarks are used to generate registration marks, positioning aids, centering aids, and starting points for passages. This advantageously simplifies the further processing of the GDL to form the fuel cell stack, since precise positioning of the GDL relative to the other components, such as BPP or CL, is possible by means of, for example, transmitted-light/reflected-light image processing systems.

According to a further preferred embodiment, the patterns of the GDL of the anode side and of the cathode side are not identical, but instead have precise mirror symmetry in the area and in the material-thickness direction. Expressed alternatively, the patterns of the GDL of the anode side are phase-shifted by 180° relative to the patterns of the GDL of the cathode side. This means that when an anode GDL is placed by the flow field side onto the flow field side of a cathode GDL, the elevations of the one GDL coincide exactly with the depressions of the other GDL. Placed one over the other, therefore, the combination of two anode/cathode GDLs with 3D mirror symmetry produces an exactly planar piece of green paper. This embodiment has the advantage that the green paper can be densified with any mechanical pressure without losing its channel pattern. The reason is that the elevations and depressions in the green paper, generated by the watermark and forming flow field channels, are neither damaged, pressed back or leveled by subsequent pressing and other mechanical loads, and so the channels are able to remain effective. This embodiment also has the further advantage that the anode GDL and the cathode GDL can have a different porosity. Alternatively to the alternating structure of anode GDL and cathode GDL, it is also possible for every other anode/cathode pair in the stack, or every other stack, to be furnished with 3D mirror-symmetrical GDLs.

With particular preference the fuel cell is a proton exchange membrane fuel cell (PEMFC). According to one preferred embodiment, the first paper web in this case forms a diffusion layer for a membrane (CL) coated with catalytic metal, preferably platinum, in the gas diffusion layer produced from the green paper, and the second paper web forms a distribution layer with flow field in the gas diffusion layer produced from the green paper. However, the GDL produced from a green paper of the invention may also be used for other types of fuel cells which require a porous, conductive layer for gas distribution, as for example a proton exchange membrane electrolyzer cell (PEMEC), electrolyzer cells, or another power-to-X technology.

Constituents of the paper web include preferably paper from cellulose fibers or from cotton fibers, as is used for banknotes, for example, or from other natural fibers or from synthetic fibers, or from a mixture of natural and synthetic fibers. With additional preference, the paper web consists of a combination of at least two different substrates, which are arranged one above the other and connected to one another—a hybrid. Data regarding the weight of the paper web used are reported for example in the text DE 102 43 653 A9, the relevant observations in which are incorporated in full into the present patent application. The metal-filled green paper may have a grammage of 100 g/m² to 1200 g/m².

Filler materials used for the sinter paper may be all metal powders and metal fibers on a micro scale, examples being titanium, copper, zinc or rustless stainless steels, of the kind known from DE 10 2008 042 415 B3. It is important here that different mixtures are used for the former ply and for the cylindrical wire ply, in order to achieve a different porosity in the paper plies. The former ply here is to be made finer than the cylindrical wire ply. In the former ply it is also possible for nanopowders to be employed.

In order to protect the metals down into the smallest pores from corrosion and to generate the usually desired hydrophobic properties preferably on the catalyst-facing side, according to a further preferred embodiment, a (thermal) ALD coating or other coating methods are used in one of the subsequent operating steps. Preferably after the debindering and sintering and before the stamping and converting of the GDL, where the cuts lie outside the region at risk of corrosion, or the cuts are given extra sealing in the further operating steps for the completed cell. Otherwise, the possibility also exists of coating the GDL after the punching and converting with ALD, etc.

It is appreciated that the features stated above and those still to be elucidated hereinafter can be employed not only in the specified combinations but also in other combinations without departing the ambit of the present invention, insofar as is encompassed by the scope of protection of the claims.

The advantages of the invention are elucidated with reference to the exemplary embodiments below and to the supplementary figures. The exemplary embodiments constitute preferred embodiments, but without any intention at all for the invention to be confined to them. Furthermore, for greater ease of understanding, the representations in the figures are highly schematized and do not reflect the actual circumstances. In particular, the proportions shown in the figures do not match the conditions present in reality, and serve solely to improve clearness. Furthermore, the embodiments described in the exemplary embodiments below are reduced to the essential core information, for greater ease of understanding. In the practical implementation, substantially more complex designs or images may be employed.

In detail and schematically:

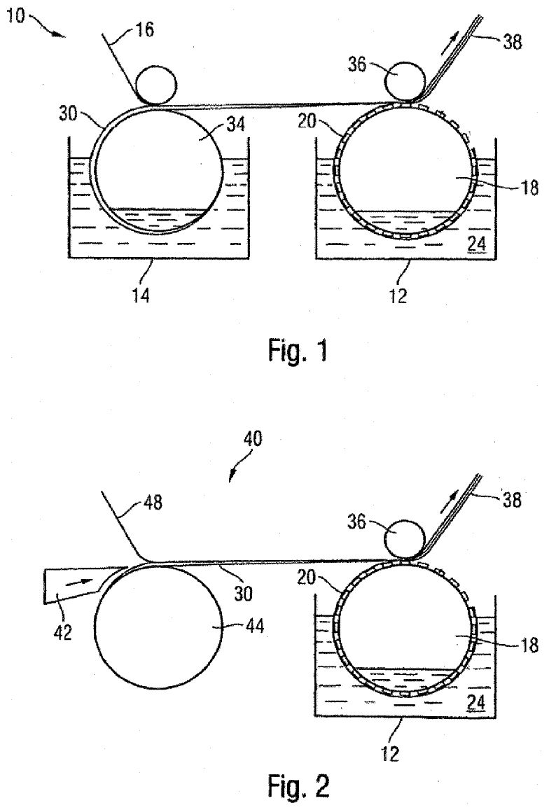

FIG. 1 shows a double-cylindrical paper machine for producing a green paper of the invention,

FIG. 2 shows a cylindrical paper machine and a short former in schematic representation,

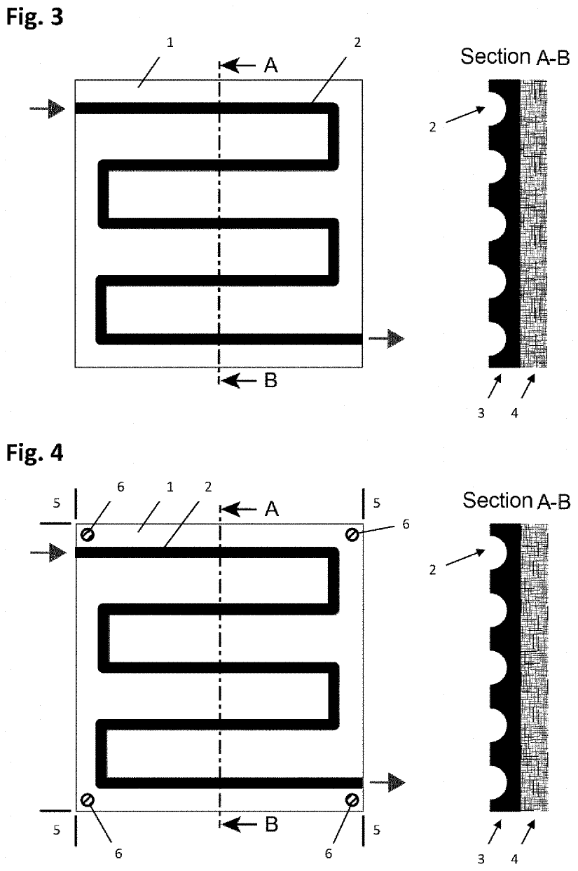

FIG. 3 shows a two-ply GDL having a serpentine channel shaped by a watermark, in plan view on the left and in sectional representation along the section A-B on the right,

FIG. 4 shows the two-ply GDL from FIG. 3, additionally with registration marks, positioning aids and centering aids,

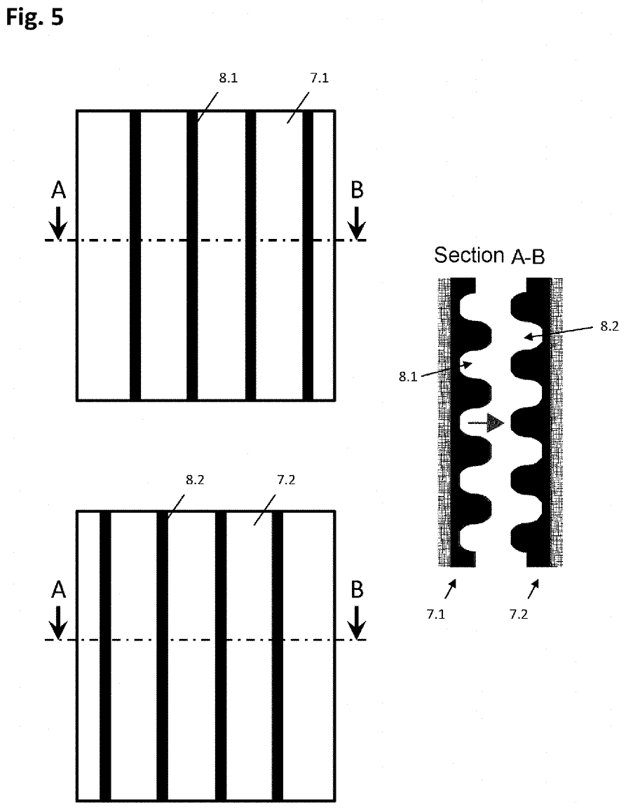

FIG. 5 shows a combination of two 3D mirror-symmetrical anode and cathode GDLs, in each case in plan view on the left and in sectional representation along the section A-B on the right,

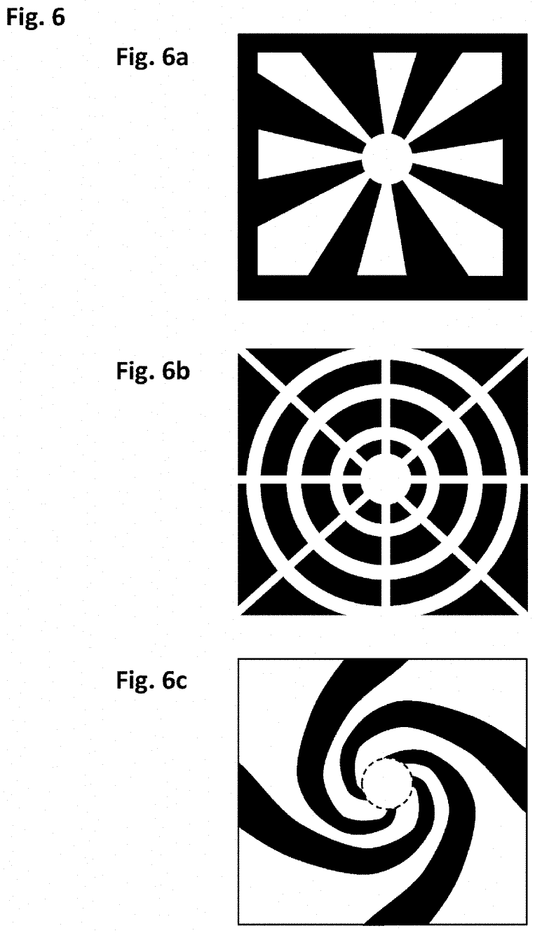

FIG. 6 shows a GDL having channels shaped by a watermark, these channels leading outward from the middle of the GDL, with ray-shaped channels in FIG. 6a, with ray-shaped and concentric channels in FIG. 6b, and with spiral-shaped channels in FIG. 6c.

FIG. 1 shows in schematic representation a double-cylindrical paper machine 10, as is known for the production of security paper from WO 2006/099971 A2, for example. The paper machine 10 contains two cylindrical paper machines 12 and 14, which are connected to one another via a transfer felt 16.

In the first paper machine 12, a paper web 20 is formed on a cylindrical wire 18. In the second paper machine 14, in parallel with this, a second, homogeneous paper web 30 is produced, is taken from the cylindrical wire 34 by means of the transfer felt 16 and is passed to the first paper machine 12, where it is joined to the first paper web 20 in the region of the pinch roller 36. The paper webs 38 joined to one another together form the GDL and are passed to further processing stations.

As represented in FIG. 2, the second paper web 30 may also be generated with a short former 40, in which the paper stock is applied with a head-box nozzle 42 onto the surface of a cylindrical wire 44. With a short former of this kind it is possible to generate particularly thin paper plies, having a grammage for example of 15 to 25 g/m2.

It is appreciated that with the paper machines 12, 14, 40 shown, it is also possible analogously to generate and bring together three or more paper webs.

FIG. 3 shows schematically a two-ply GDL 1 having a serpentine channel 2 shaped by a watermark, in plan view on the left and in sectional representation along the section A-B on the right.

In the section A-B, the black region 3 shows the cylindrical wire ply with patterned watermark as channel 2, and the shaded region 4 shows the former ply with fine pore structure. Depending on configuration, the individual plies 3 and 4 may have a different basic thickness. Apparent along the serpentine pattern of the channel 2 in the example above is a sectional profile shaped by the watermark, apparent as a thickness modulation through the cylindrical wire ply, which in the drawing has a semicircle shape. In principle, any conceivable profile shape is possible here that does not possess undercuts and forms a wall angle <80°. The large arrows show the gas inlet/outlet. The gasket around the GDL must be designed accordingly.

FIG. 4 shows schematically the two-ply GDL from FIG. 3, supplemented by registration marks, positioning aids and centering aids.

By means of highlight watermarks it is possible to incorporate registration marks, positioning aids, centering aids, and starting points for passages, in order to simplify the further processing of the GDL to form the fuel cell stack. Such incorporation ensures that, using transmitted-light/reflected-light image processing systems, for example, precise positioning of the GDL relative to the other components, such as BPP or CL, is possible.

The lines 5 are intended to represent cutting marks for the GDL, realized for example as highlight watermarks, and the circles 6 are intended to represent centering/positioning aids. They may of course be made in any desired form. It would also be possible to employ HD watermark laser screens.

FIG. 5 shows schematically a combination of an anode GDL 7.1 and of a cathode GDL 7.2, formed with 3D mirror symmetry to said anode, the figure showing at the top left a plan view of the surface of the anode GDL 7.1, at the bottom left a plan view of the surface of the cathode GDL 7.2, and on the right in each case a sectional representation along the section A-B.

The elevations and depressions in the green paper and in the completed GDL, these elevations and depressions being generated by the watermark and forming flow field channels 8.1 and 8.2, may be damaged again, pressed back or even levelled by pressing and other mechanical loads, meaning that the channels 8.1 and 8.2 may no longer be fully effective.

This problem can be eliminated by the patterns, generated by watermark, in the GDLs of the anode side and of the cathode side being not identical but instead exactly mirror-symmetrical in the area, but also in the material-thickness direction. This means, when the anode GDL 7.1 is placed by the flow field side onto the flow field side of the cathode GDL 7.2, the elevations and depressions of the channels 8.1 and 8.2 arranged in parallel cancel one another out exactly. The combination of two anode/cathode GDLs with 3D mirror symmetry hence produces a planar piece of sinter paper which can be densified with any pressure without losing its channel pattern.

Furthermore, the anode GDL 7.1 and the cathode GDL 7.2 may have a different porosity. For example, the anode GDL 7.1 may have a porosity of 20% to 75% and the cathode GDL 7.2 a porosity of 30% to 90%, with the cathode GDL 7.2 therefore acting hardly as resistance for the gas, but instead only as a spacer with respect to the bipolar plate.

FIG. 6, in plan view in FIGS. 6a, 6b and 6c, shows three embodiments in which the gases are coupled into the GDL in the middle of the bipolar plates (not represented) and then distributed toward the outside or toward the outer edge of the GDL via various watermark patterns and/or channels in the GDL.

According to FIG. 6a, the channels of the watermark patterns have a ray-shaped design, starting from the middle of the GDL. The gases are supplied via the circular opening in the middle of the GDL; the regions shown in black constitute the regions of the watermark which have a higher thickness of the GDL than the regions shown in white, with reduced thickness of the GDL, which form the channels.

FIG. 6b shows an exemplary embodiment in which radial channels of the watermark patterns are supplemented by concentric annular channels, so producing a pattern resembling a spider's web. The gases are supplied via the circular opening in the middle of the GDL; the regions shown in black constitute the regions of the watermark which have a higher thickness of the GDL than the regions shown in white, with reduced thickness of the GDL, which form the channels.

FIG. 6c shows an exemplary embodiment in which the channels of the watermark patterns have a spiral-shaped design, starting from the middle of the GDL. The gases are supplied via the circular opening in the middle of the GDL; the regions shown in black constitute the regions of the watermark which have a higher thickness of the GDL than the regions shown in white, with reduced thickness of the GDL, which form the channels.

1.-15. (canceled)

16. A green paper for producing a gas diffusion layer (GDL) for a fuel cell,
wherein the green paper has at least one first paper web, in which at least one watermark is made, where the watermark forms a patterning for the flow field of the gas diffusion layer produced from the green paper.

17. The green paper according to claim 16, wherein the watermark is a true watermark, in which the thickness of the paper varies but the density of the paper does not vary, and/or in that the watermark is a false watermark, in which the thickness of the paper is reduced but at the same time the density of the paper is increased.

18. The green paper according to claim 16, wherein the green paper has a first paper web and at least one second paper web.

19. The green paper according to claim 16, wherein the watermark is configured as a recess in the form of at least one channel.

20. The green paper according to claim 16, wherein the watermark has little or virtually no patterning so as in the GDL to generate registration marks, positioning aids, centering aids or starting points for passages.

21. The green paper according to claim 16, wherein the patterns of the watermark of the anode side and of the cathode side of the fuel cell are not identical but are instead exactly mirror-symmetrical in the area and in the material-thickness direction.

22. A process for producing a green paper for producing a gas diffusion layer (GDL) for a fuel cell,
wherein at least one first paper web, admixed with metal powder and/or metal fibers, is generated, with at least one watermark being made in the paper web, in order to form a patterning for the flow field of the gas diffusion layer produced from the green paper.

23. The process according to claim 22, wherein the watermark is formed by a true watermark, in which the thickness of the paper varies but the density of the paper does not vary, and/or in that the watermark is formed by a false watermark, in which the thickness of the paper is reduced but at the same time the density of the paper is increased.

24. The process according to claim 22, wherein a first paper web is formed, and a second paper web is formed, the web in the still-wet state being brought together with and firmly joined to the first paper web, where the first paper web and the second paper web together form a green paper for the GDL.

25. The process according to claim 24, wherein the first and/or second paper web is generated in a cylindrical paper machine.

26. The process according to claim 24, wherein the first and/or second paper web is generated in a short former wherein the paper stock is applied via nozzle to a cylindrical wire.

27. The process according to claim 24, wherein the first paper web has a higher density than the second paper web, where the first paper web has a density of 3 g/cm³ to 10 g/cm³ and the second paper web has a density of 1 g/cm³ to 5 g/cm³.

28. The process according to claim 27, wherein the first paper web is formed by a finer paper fiber slurry than the second paper web.

29. The process according to claim 24, wherein the first paper web forms a diffusion layer for a membrane coated with catalytic metal, platinum, in the gas diffusion layer produced from the green paper, and the second paper web forms a distribution layer with flow field in the gas diffusion layer produced from the green paper.

30. The use of a gas diffusion layer (GDL) produced from a green paper according to claim 16, in a proton exchange membrane fuel cell (PEMFC), in a proton exchange membrane electrolyzer cell (PEMEC), in electrolyzer cells or in another power-to-X technology which requires correspondingly porous, conductive material for gas/power/reactant distribution.
